(19) United States
(12) Patent Application Publication
(10) Pub. No.: US 2002/0040349 A1
(43) Pub. Date: Apr. 4, 2002

(54) Copyright information inquiring apparatus

(76) Inventor: Akihisa Takayama, Maebashi (JP)

Correspondence Address: STAAS & HALSEY LLP, 700 11TH STREET, NW, SUITE 500, WASHINGTON, DC, 20001, US

(21) Appl. No.: 09/790,693

(22) Filed: Feb. 23, 2001

(30) Foreign Application Priority Data
Oct. 4, 2000 (JP) 2000-305302

(51) Int. Cl. G06F 17/60; H04K 1/00; H04L 9/00

(52) U.S. Cl. 705/57

(57) ABSTRACT

A terminal unit is provided outside of the IC card. This terminal unit includes a control section which selects, through an IC card writer/reader, one application program out of many application programs stored in the IC card. The terminal unit then boots a copyright inquiring section which inquires the copyright information about selected the application program and thereafter receives the copyright information.

### FIELD OF THE INVENTION

The present invention relates to a copyright information inquiring apparatus which can be used to inquire copyright information about an application program to be executed by an IC (Integrated Circuit) card or the like.

### BACKGROUND OF THE INVENTION

Recently, an IC card provided with an IC for executing an application program has been used in various fields. An IC card is used for an electronic money card, credit card, ID card and autonomy card. Thus, because the purpose of an IC card is expanded, it has been more important to protect the copyright of the above application program.

A conventional IC card is provided with a memory region for storing an application program so that it is impossible to refer to a program code from an external terminal in order to prevent an illegal copy. Moreover, in case of a conventional IC card, it is impossible to inquire the copyright information about an application program by an access from an external terminal after storing the application program in a memory region in order to keep the security.

As described above, in case of a conventional IC card, it is impossible to inquire the copyright information about an application program stored in a memory region from an external terminal in order to keep the security.

However, a problem occurs when a third party illegally carries an application program generated through a formal route to an external unit. That is, when an application program illegally carried out by a third party is illegally stored in the memory region of other IC card, it is impossible to inquire copyright information even if the illegal IC card is sold and used. Therefore, it is very difficult to expose the above wrongdoing and thus, the above mentioned is not preferable from the viewpoint of copyright protection.

### SUMMARY OF THE INVENTION

It is an object of this invention to provide a copyright information inquiring apparatus capable of inquiring the copyright information about a program stored in an IC card from an external unit.

The copyright information inquiring apparatus according to one aspect of the present invention comprises a program designating unit which designates a program stored in an IC card through communication unit, a booting unit which boots a copyright information inquiring unit which inquires the copyright information about a program designated by the program designating unit provided for the IC card and a receiving unit which receives the copyright information inquired by the copyright information inquiring unit.

According to the above-mentioned aspect, copyright information inquiring unit is booted by designating a program stored in an IC card by program designating unit. Therefore, it is possible to inquire the copyright information about the program from an external unit.

Other objects and features of this invention will become apparent from the following description with reference to the accompanying drawings.

### BRIEF DESCRIPTION OF THE DRAWINGS

FIG. 1 is a block diagram showing a configuration of first to fifth embodiments of the present invention;

FIG. 2A and FIG. 2B are illustrations showing data structures of the copyright information storing section 52 and card status storing section 55 shown in FIG. 1;

FIG. 3 is an illustration for explaining operations of the first embodiment of the present invention;

FIG. 4 is a flowchart for explaining operations of a control section 11 of first and sixth embodiments of the present invention;

FIG. 5 is a flowchart for explaining operations of control sections 57 and 66 of the first and sixth embodiments;

FIG. 6 is a flowchart for explaining operations of copyright inquiring sections 56 and 65 of the first to eighth sixth embodiments of the present invention;

FIG. 7 is an illustration for explaining operations of the second embodiment of the present invention;

FIG. 8 is a flowchart for explaining operations of the control section 11 of the second and seventh embodiments of the present invention;

FIG. 9 is a flowchart for explaining operations of control sections 57 and 66 of the second and seventh embodiments of the present invention;

FIG. 10 is an illustration for explaining operations of the third embodiment of the present invention;

FIG. 11 is a flowchart for explaining operations of the control section 11 of the third and eighth embodiments of the present invention;

FIG. 12 is a flowchart for explaining operations of control sections 57 and 66 of the third and eighth embodiments of the present invention;

FIG. 13 is an illustration for explaining operations of the fourth embodiment of the present invention;

FIG. 14 is a flowchart for explaining operations of the control section 11 of the fourth embodiment;

FIG. 15 is a flowchart for explaining operations of the control section 57 of the fourth embodiment;

FIG. 16 is an illustration for explaining operations of the fifth embodiment of the present invention;

FIG. 17 is a flowchart for explaining operations of the control section 11 of the fifth embodiment;

FIG. 18 is a flowchart for explaining operations of the control section 57 of the fifth embodiment;

FIG. 19 is a block diagram showing a configuration of the sixth to eighth embodiments of the present invention;

FIG. 20A to FIG. 20C are illustrations showing data structures of the first copyright information storing section 63₁, second copyright information storing section 63₂ and card status storing section 64 shown in FIG. 19;

FIG. 21 is an illustration showing a data structure of the card status storing section 67 shown in FIG. 19;

FIG. 22 is an illustration for explaining operations of the sixth embodiment of the present invention;

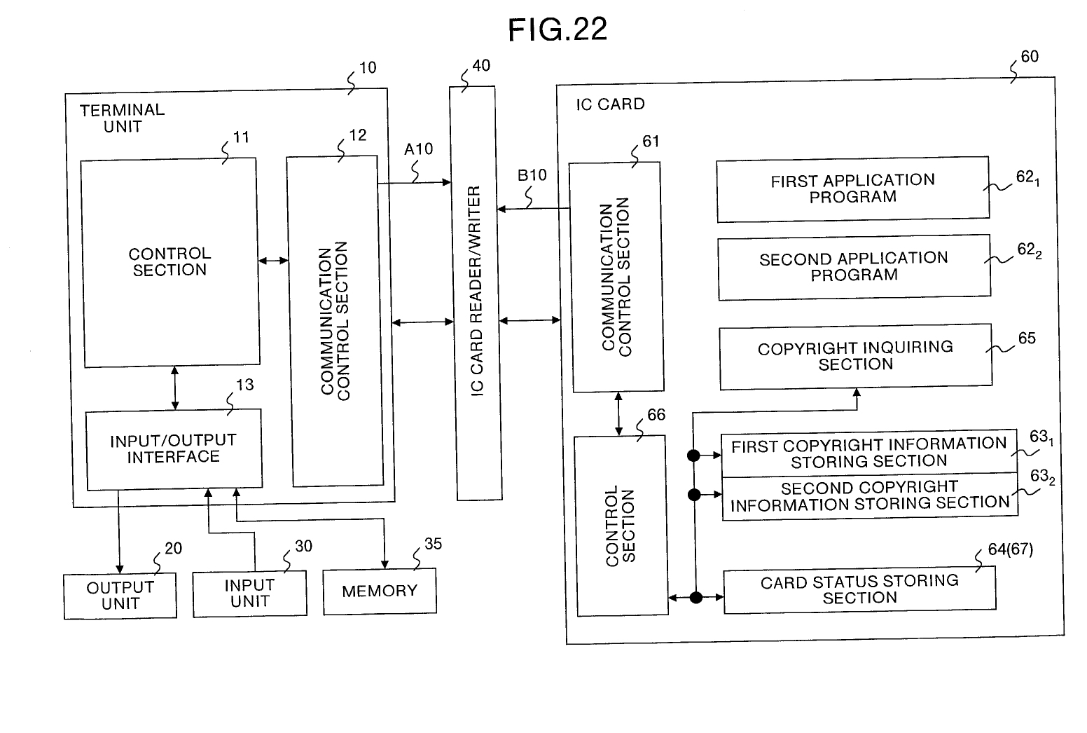

FIG. 23 is an illustration for explaining operations of the seventh embodiment of the present invention; and

FIG. 24 is an illustration for explaining operations of the eighth embodiment of the present invention.

### DESCRIPTION OF THE PREFERRED EMBODIMENTS

Preferred embodiments of the copyright information inquiring apparatus according to the present invention are described below in detail by referring to the accompanying drawings.

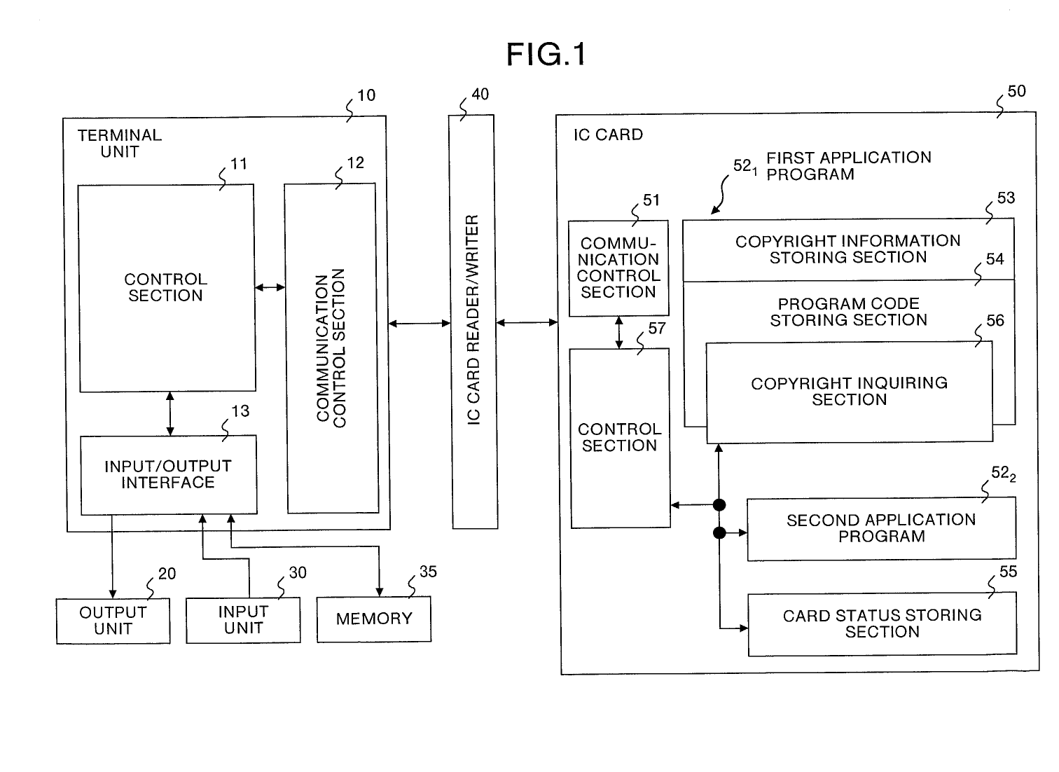

FIG. 1 is a block diagram showing a configuration of first embodiment. In FIG. 1, a terminal unit 10 serves as a copyright information inquiring apparatus for communicating with various sections of an IC card 50 through an IC card reader/writer 40 to inquire the copyright information about an application program stored in the IC card 50. In the terminal unit 10, a control section 11 controls various sections and details of operations of the control section 11 will be described later.

A communication control section 12 controls communication with an external unit (in this case, IC card 50) in accordance with a predetermined communication protocol. An input/output interface 13 serves as an interface between the control section 11 on one hand and an output unit 20, input unit 30 and memory 35 on the other. The output unit 20 uses a display or printer. The input unit 30 uses a keyboard or mouse. The memory 35 stores various data values.

The IC card reader/writer 40 has a function for reading information from the IC card 50 and a function for writing information in the IC card 50. The IC card 50 is a card provided with an IC (not illustrated) for executing an application program. In the IC card 50, a communication control section 51 controls communication with an external unit (in this case, the terminal unit 10) in accordance with a predetermined communication protocol. The IC card 50 stores a first application program 52₁ and a second application program 52₂ to be executed by an IC.

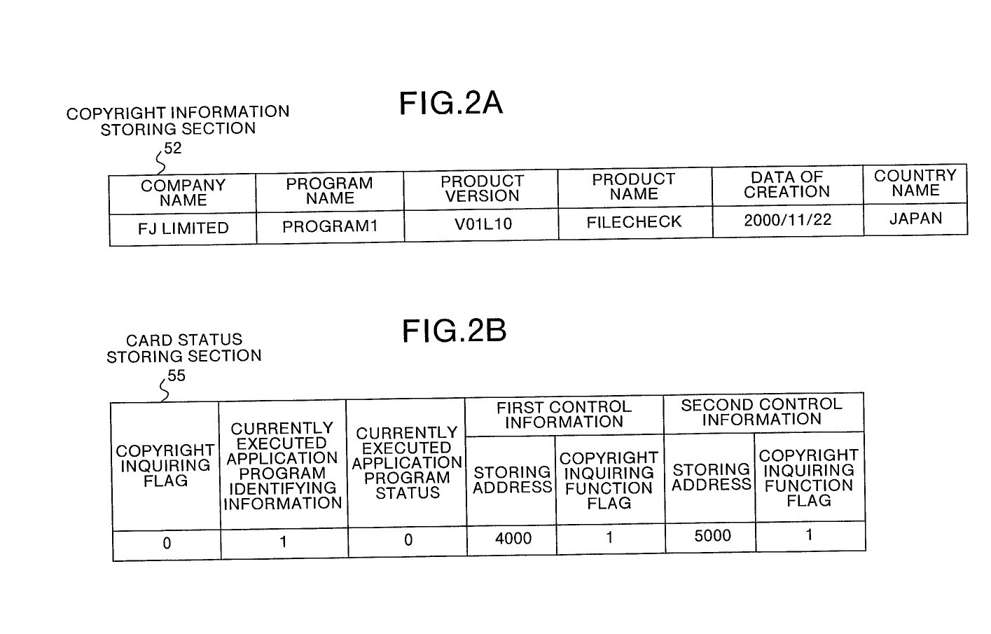

In the first application program 52₁, a copyright information storing section 53 stores the copyright information about the first application program 52₁ as shown in FIG. 2A. The copyright information includes “company name”, “program name”, “product version”, “product name”, “date of creation” and “country name”. In FIG. 1, a program code storing section 54 stores the program code of the first application program 52₁. The second application program 52₂ is constituted the same as the first application program 52₁ is.

A card status storing section 55 stores a card status. Specifically, as shown in FIG. 2B, the section 55 is provided with such fields as “copyright inquiring flag”, “currently executed application program identifying information”, “currently executed application program status”, “first control information” and “second control information”.

The “copyright inquiring flag” is a flag for controlling whether to perform an inquiry of copyright information (hereafter referred to as copyright inquiry) in the IC card 50. When performing the copyright inquiry, 0 is set to the “copyright inquiring flag”. However, when not performing the copyright inquiry, 1 is set to the “copyright inquiring flag”.

The “currently executed application program identifying information” is the information for identifying an application program currently executed in the IC card 50. When the first application program 52, is executed, 1 is set to the “currently executed application program identifying information”.

However, when the second application program 52₂ is executed, 2 is set to the “currently executed application program identifying information”. When neither application program is executed, 0 is set to the “currently executed application program identifying information” but copyright inquiry is not performed.

A copyright processing status (0: not start of copyright inquiry) of an application program currently executed in the IC card 50 is set to the “currently executed application program status”. The “first control information” is constituted of a “storing address” and a “copyright inquiring function flag” corresponding to the first application program 52₁. The “storing address” is the information showing an address in which the first application program 52₁ is stored.

The “copyright inquiring function flag” is a flag for controlling on/off of a copyright inquiring function about the first application program 52₁. When the copyright inquiring function about the first application program 52₁, is off, 0 is set to the “copyright inquiring function flag”. However, when the copyright inquiring function about the first application program 52₁ is off, 1 is set to the “copyright inquiring function flag”.

The “second control information” is constituted of a“storing address” and a“copyright inquiring function flag” corresponding to the second application program 52₂. The “storing address” is the information showing an address in which the second application program 52₂ is stored.

The “copyright inquiring function flag” is a flag for controlling on/off of the copyright inquiring function about the second application program 52₂. When the copyright inquiring function about the second application program 52₂ is off, 0 is set to the “copyright inquiring function flag”. However, when the copyright inquiring function about the second application program 52₂ is on, 1 is set to the “copyright inquiring function flag”.

A copyright inquiring section 56 inquires the copyright information about the first application program 52₁. The second application program 52₂ is also provided with a copyright inquiring section (not illustrated) having the same function as the copyright inquiring section 56. A control section 57 controls various sections and details of operations of the control section 57 will be described later.

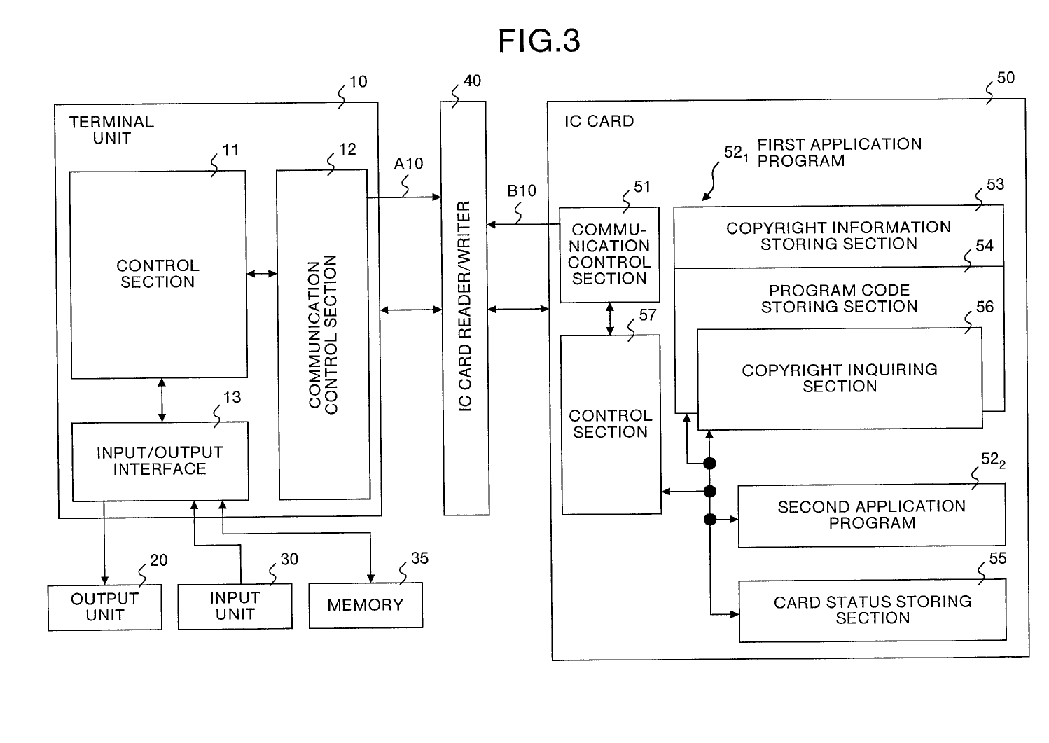

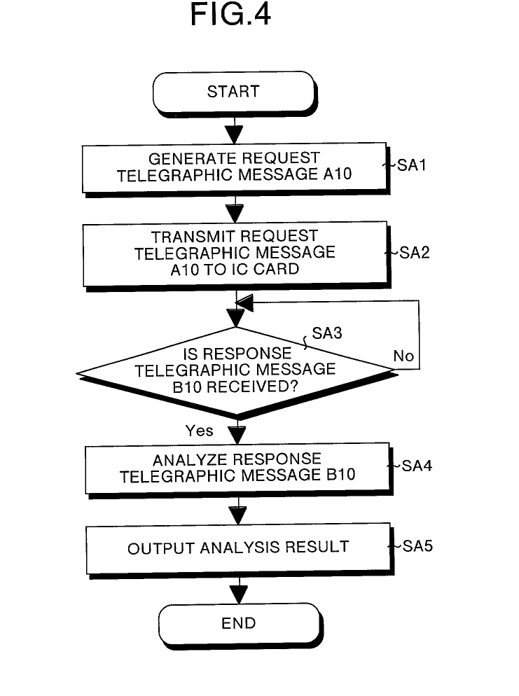

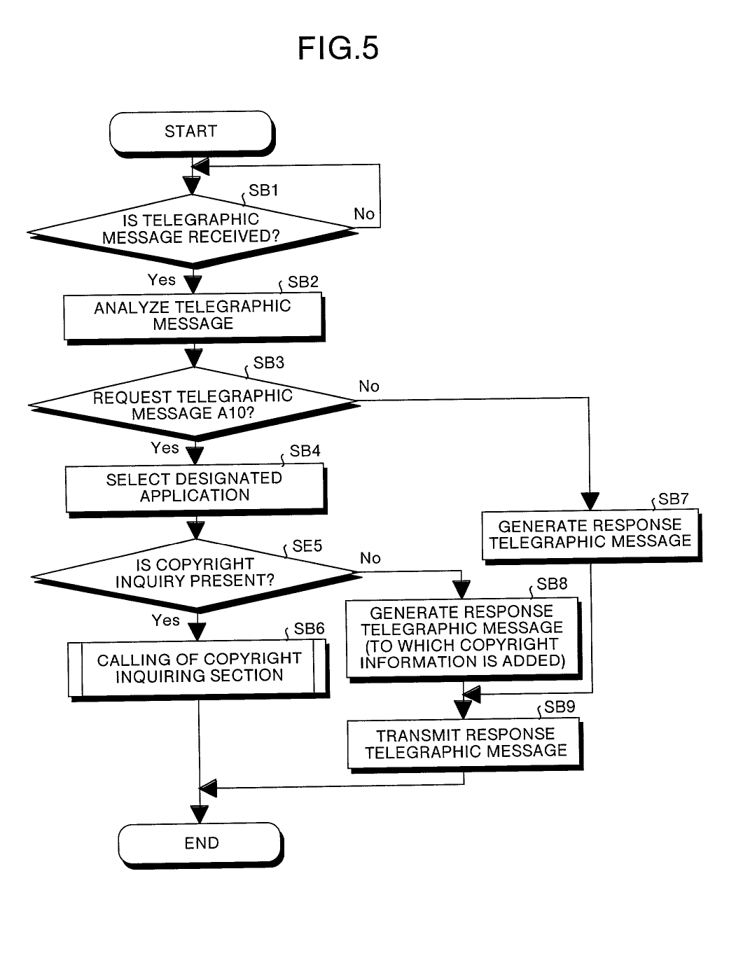

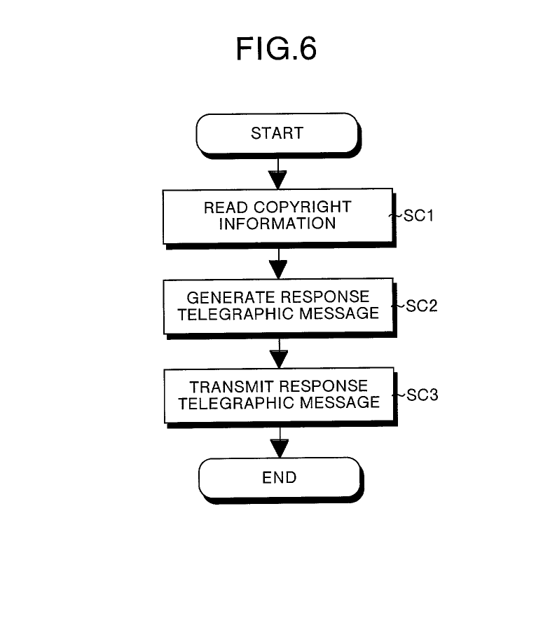

Then, operations of the above first embodiment are described below by referring to FIG. 3 to FIG. 6. FIG. 3 is an illustration for explaining operations of the first embodiment. FIG. 4 is a flowchart for explaining operations of the control section 11 of the terminal unit 10 of the first embodiment. FIG. 5 is a flowchart for explaining operations of the control section 57 of the IC card 50 of the first embodiment. FIG. 6 is a flowchart for explaining operations of copyright inquiring section 56 of the IC card 50.

First, in step SB1 shown in FIG. 5, the control section 57 determines whether a electronic message is received. When the determination result is “No”, the section 57 repeats the above determination. However, in step SA1 shown in FIG. 4, the control section 11 generates a request electronic message A10. The request electronic message A10 is used to select an application program (in FIG. 5, first application program 52₁ or 52₂) stored in the IC card 50. Moreover, the request electronic message A10 includes the copyright inquiry information for showing whether a copyright inquiry is present.

In step SA2, the control section 11 transmits the request electronic message A10 to the IC card 50. In step SA3, the control section 11 determines whether a response electronic message B10 is received from the IC card 50. When the determination result is “No”, the control section 11 repeats the above determination.

Then, when the request electronic message A10 is received by the control section 57 via the communication control section 12, the IC card reader/writer 40 and the communication control section 51, the control section 57 sets the determination result in step SB1 in FIG. 5 to “Yes”. In step SB2, the control section 57 analyzes the received electronic message. In step SB3, the control section 57 determines whether the received electronic message is the request electronic message A10 in accordance with the analysis result in step SB2 and in this case, sets the determination result to “Yes”.

In step SB4, the control section 57 selects an application program (in this case, first application program 52₁) designated in accordance with the request electronic message A10. In step SB5, the control section 57 refers to the copyright inquiry information included in the request electronic message A10 to determine whether there is a copyright inquiry. In this case, the section 57 sets the determination result to “Yes”.

In step SB6, the control section 57 calls the copyright inquiring section 56. Thereby, in step SC1 shown in FIG. 6, the copyright inquiring section 56 reads the copyright information about the first application program 52₁ from the copyright information storing section 53. In step SC2, the copyright inquiring section 56 generates the response electronic message B10 to which the above copyright information is added. In step SC3, the copyright inquiring section 56 transmits the response electronic message B10 to the terminal unit 10.

Then, the response electronic message B10 is received by the control section 11 via the communication control section 51, IC card reader/writer 40 and the communication control section 12. Thereby, the control section 11 sets the determination result in step SA3 shown in FIG. 4 to “Yes”. In step SA4, the control section 11 analyzes the response electronic message B10. In step SA5, the control section 11 outputs the copyright information about the first application program 52₁ to the output unit 20 as an analysis result.

However, when the determination result in step SB3 shown in FIG. 5 is “No”, the control section 57 generates a response electronic message in step SB7. In step SB9, the control section 57 transmits the response electronic message to the terminal unit 10. However, when the determination result in step SB5 is “No”, that is, when there is no copyright inquiry, the control section 57 generates a response electronic message (to which copyright information is not added) in step SB8. In step SB9, the control section 57 transmits the response electronic message to the terminal unit 10.

In the case of the first embodiment, it is also allowed to encipher the copyright information to be added to the response electronic message B10 by the copyright inquiring section 56 and decodes the enciphered copyright information by the control section 11.

As described above, the first embodiment designates an application program stored in the IC card 50 by the control section 11 so as to start the copyright inquiring section 56. Therefore, it is possible to inquire the copyright information about the application program from an external unit.

Moreover, because the first embodiment enciphers copyright information by the IC card 50 so as to decode the information by the terminal unit 10, it is possible to improve the security.

As the first embodiment, a case is described in which the request electronic message A10 and response electronic message B10 are transferred once between the terminal unit 10 and IC card 50. However, it is also allowed to transfer the messages A10 and B10 between them a plurality of times. Hereafter, the above case is described as second embodiment. The basic configuration of the second embodiment is the same as the configuration shown in FIG. 1.

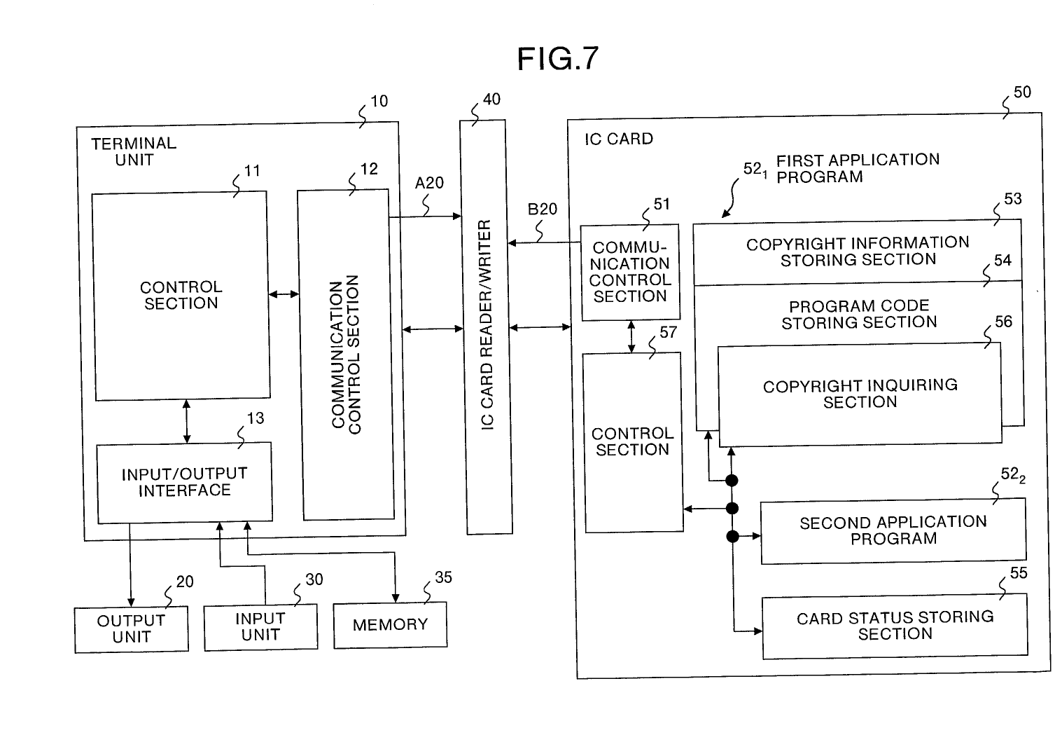

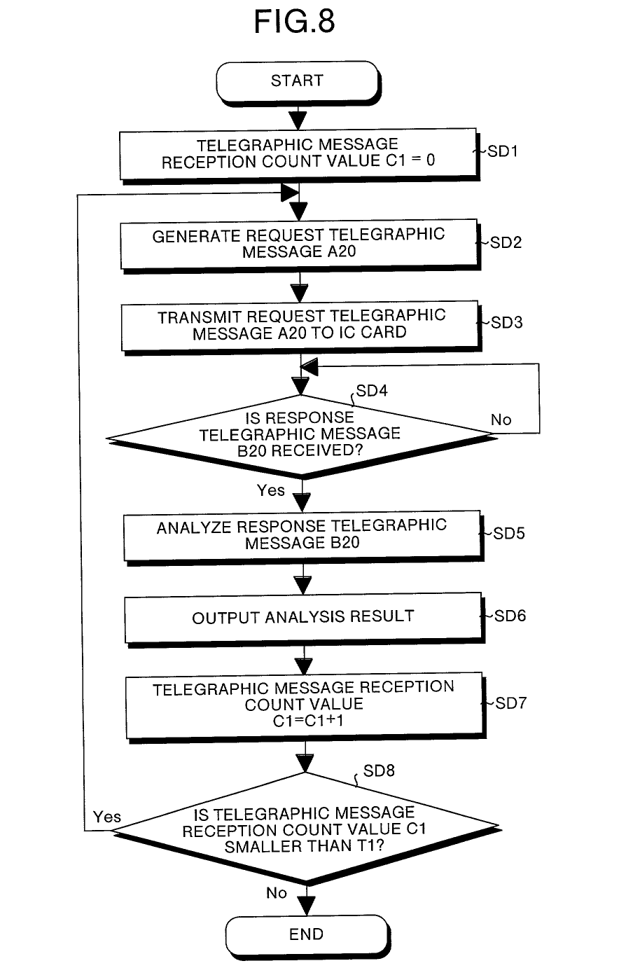

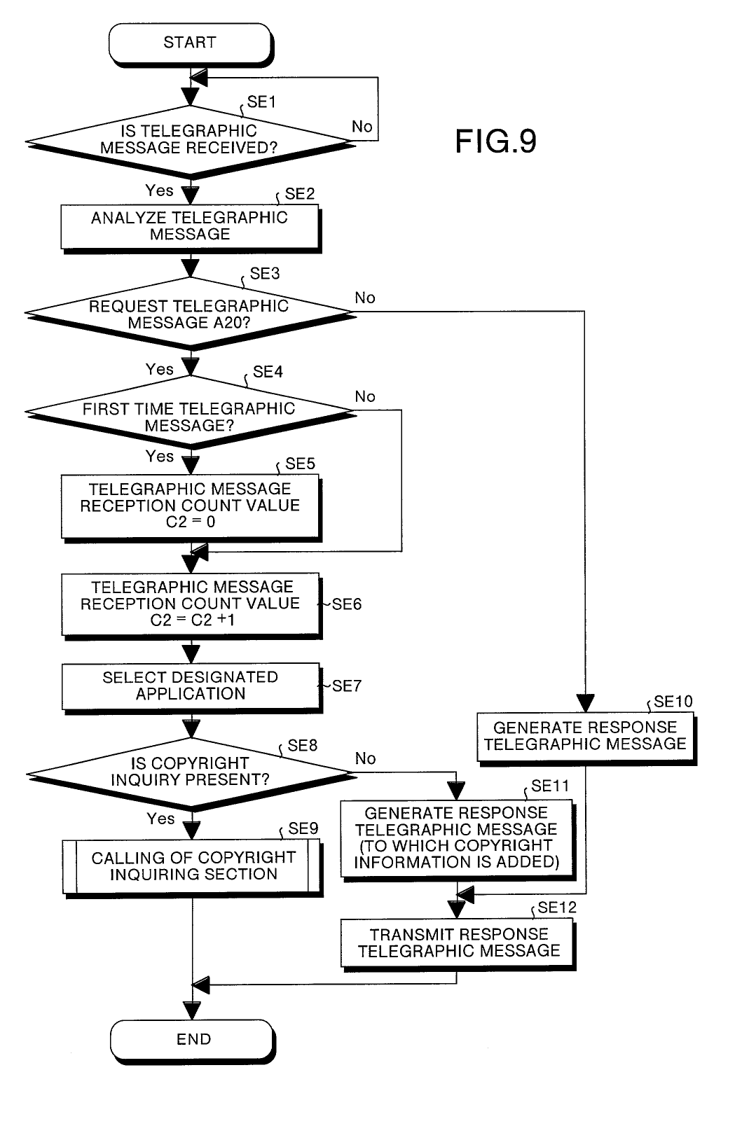

Then, operations of the above second embodiment are described below by referring to FIG. 7 to FIG. 9. FIG. 7 is an illustration for explaining operations of the second embodiment. FIG. 8 is a flowchart for explaining operations of a control section 11 of the terminal unit 10 of the second embodiment. FIG. 9 is a flowchart for explaining operations of a control section 57 of an IC card 50 of the second embodiment.

First, in step SE1 shown in FIG. 9, the control section 57 determines whether a electronic message is received. When the determination result is “No”, the section 57 repeats the above determination. In step SD1 shown in FIG. 8, however, the control section 11 substitutes 0 for a electronic message reception count value C1. In step SD2, the control section 11 generates a request electronic message A20. The request electronic message A20 is a electronic message for selecting an application program (in FIG. 9, first application program 52₁ or 52₂) stored in the IC card 50. Moreover, the request electronic message A20 includes the copyright inquiry information showing whether a copyright inquiry is present.

In step SD3, the control section 11 transmits the request electronic message A20 to the IC card 50. In step SD4, the control section 11 determines whether a response electronic message B20 is received from the IC card 50. When the determination result is “No”, the section 11 repeats the above determination.

Then, when the request electronic message A20 is received by the control section 57 via a communication control section 12, IC card reader/writer 40 and communication control section 51, the control section 57 sets the determination result in step SE1 shown in FIG. 9 to “Yes”. In step SE2, the control section 57 analyzes the received electronic message. In step SE3, the control section 57 determines whether the received electronic message is the request electronic message A20 in accordance with the analysis result in step SE2 and in this case, sets the determination result to “Yes”.

In step SE4, the control section 57 determines whether the electronic message is a electronic message received at the first time and in this case, sets the determination result to “Yes”. When the determination result in step SE4 is “No”, the control section 57 executes the processing in step SE6. In step SE5, the control section 57 substitutes 0 for a electronic message reception count value C2. In step SE6, the control section 57 increments the electronic message reception count value C2 by 1.

In step SE7, the control section 57 selects an application program (in this case, first application program 52₁) designated in accordance with the request electronic message A20. In step SE8, the control section 57 refers to the copyright inquiry information included in the request electronic message A20 to determine whether there is a copyright inquiry and in this case, sets the determination result to “Yes”.

In step SE9, the control section 57 calls a copyright inquiring section 56. Thereby, in step SC1 shown in FIG. 6, the copyright inquiring section 56 reads the copyright information about the first application program 52₁ from a copyright information storing section 53. In step SC2, the copyright inquiring section 56 generates a response electronic message B20 to which the copyright information is added. In step SC3, the copyright inquiring section 56 transmits the response electronic message B20 to the terminal unit 10.

Then, the response electronic message B20 is received by the control section 11 via the control section 57, communication control section 51, IC card reader/writer 40 and communication control section 12. Thereby, the control section 11 sets the determination result in step SD4 shown in FIG. 8 to “Yes”. In step SD5, the control section 11 analyzes the response electronic message B20. In step SD6, the control section 11 outputs the copyright information about the first application program 52₁ to an output unit 20 as an analysis result.

In step SD7, the control section 11 increments the electronic message reception count value C1 by 1. In step SD8, the control section 11 determines whether the electronic message reception count value C1 is less than a preset threshold value T1 and in this case, sets the determination result to “Yes” to execute processings from the processing in step SD2 downward. Thereafter, the above operations are repeated a plurality of times.

However, when the determination result in step SE3 shown in FIG. 9 is “No”, the control section 57 generates a response electronic message in step SE10. In step SE12, the control section 57 transmits the response electronic message to the terminal unit 10. However, when the determination result in step SE8 is “No”, that is, when there is not a copyright inquiry, the control section 57 generates a electronic message (to which copyright information is not added) in step SE11. In step SE12, the control section 57 transmits the above response electronic message to the terminal unit 10.

Then, when the electronic message reception count value C1 exceeds the threshold value T1, the control section 11 sets the determination result in step SD8 to “Yes” and completes a series of processings. In the case of the second embodiment, it is also allowed to encipher the copyright information to be added to the response electronic message B20 by the copyright inquiring section 56 and decode the enciphered copyright information by the control section 11.

As described above, according to the second embodiment, the copyright inquiring section 56 is repeatedly started. Therefore, it is possible to inquire copyright information even if a slight communication trouble occurs.

In the first embodiment, whether a copyright inquiry is present is controlled in accordance with the copyright inquiry information included in the request electronic message A10 (refer to FIG. 2A and FIG. 2B). However, it is also allowed to control the “copyright inquiring flag” shown in FIG. 2B by the terminal unit 10. Hereafter, the above case is described as third embodiment. The basic configuration of the third embodiment is the same as the configuration shown in FIG. 1.

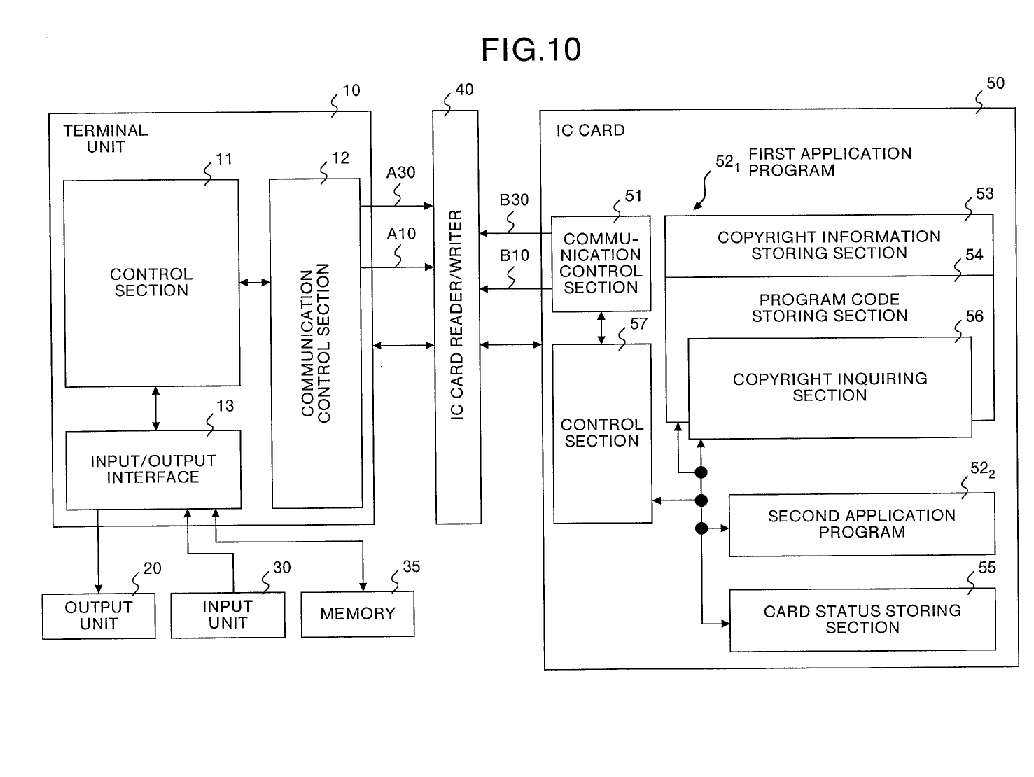

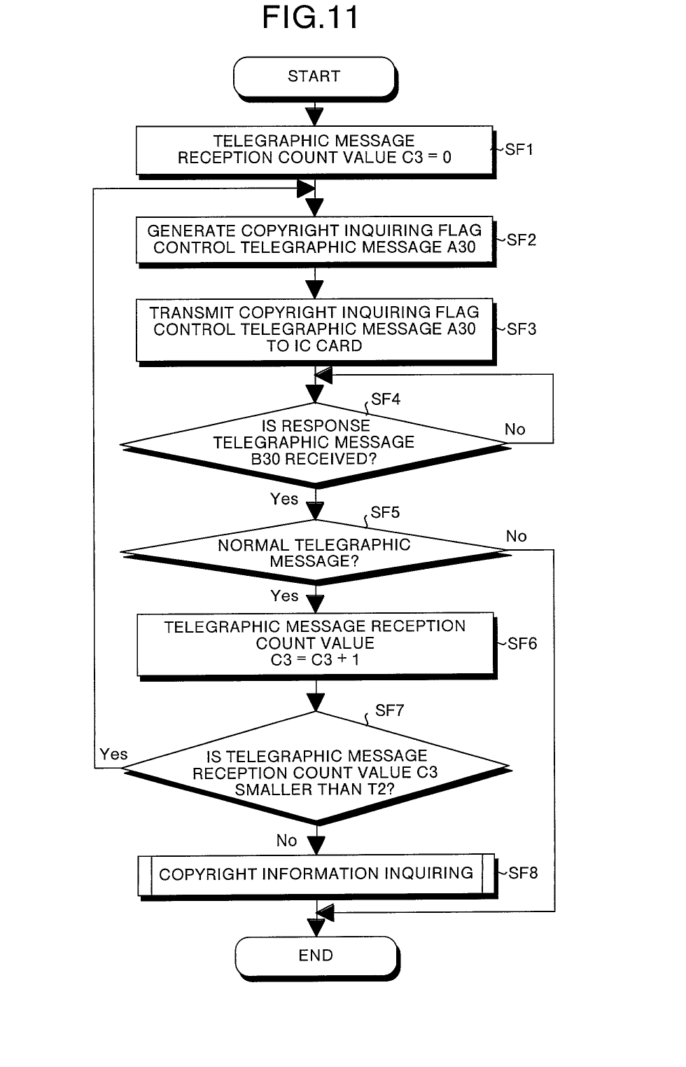

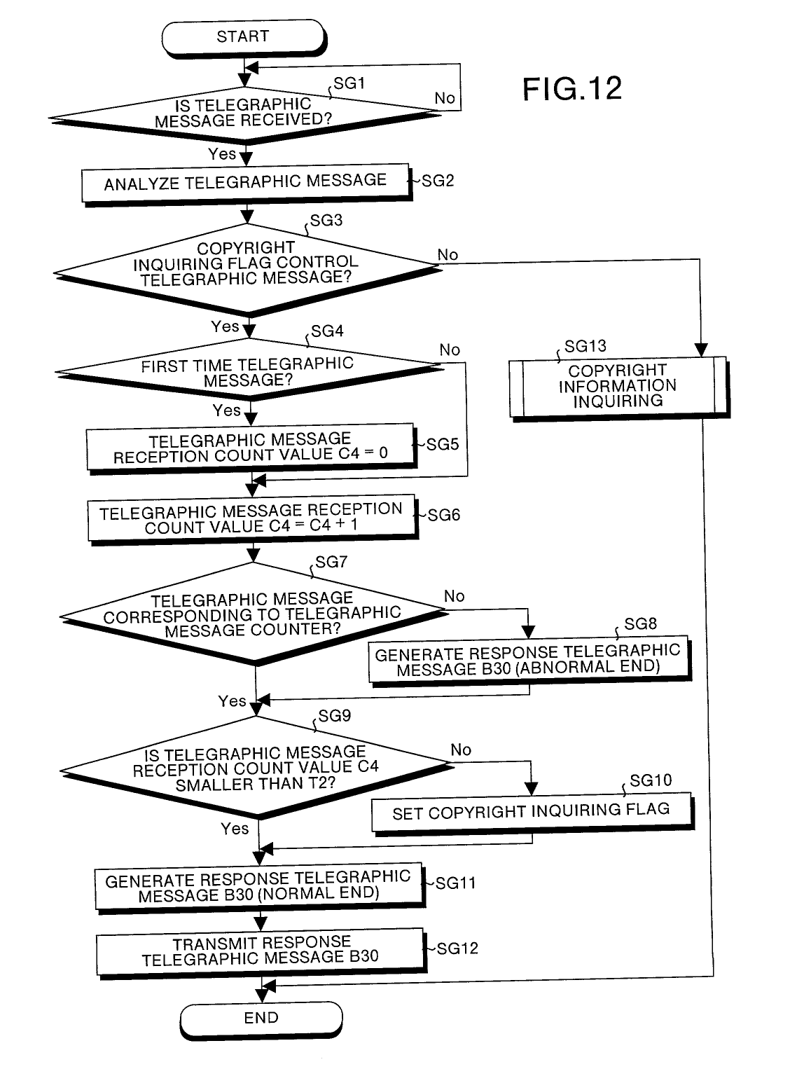

Then, operations of the third embodiment are described below by referring to FIG. 10 to FIG. 12. FIG. 10 is an illustration for explaining operations of the third embodiment. FIG. 11 is a flowchart for explaining operations of the terminal unit 10 and a control section 11 of the third embodiment. FIG. 12 is a flowchart for explaining operations of a control section 57 of an IC card 50 of the third embodiment.

First, in step SG1 shown in FIG. 12, the control section 57 determines whether a electronic message is received. When the determination result is “No”, the section 57 repeats the above determination. In step SF1 shown in FIG. 11, the control section 11 substitutes 0 for a electronic message reception count value C3. In step SF2, the control section 11 generates a copyright inquiring flag control electronic message A30. The copyright inquiring flag control electronic message A30 is used to set 0 or 1 to the “copyright inquiring flag” shown in FIG. 2B.

In step SF3, the control section 11 transmits the copyright inquiring flag control electronic message A30 to the IC card 50. In step SF4, the control section 11 determines whether a response electronic message B30 is received from the IC card 50. When the determination result is “No”, the section 11 repeats the above determination.

Then, when the copyright inquiring flag control electronic message A30 is received by the control section 57 via the communication control section 12, the IC card reader/writer 40 and the communication control section 51, the control section 57 set the determination result in step SG1 shown in FIG. 12 to “Yes”. In step SG2, the control section 57 analyzes the received electronic message. In step SG3, the control section 57 determines whether the received electronic message is the copyright inquiring flag control electronic message A30 in accordance with the analysis result in step SG2 and in this case, sets the determination result to “Yes”.

In step SG4, the control section 57 determines whether the electronic message concerned is a electronic message received at the first time and in this case, sets the determination result to “Yes”. However, when the determination result in step SG4 is “No”, the control section 57 executes the copyright information inquiring in step SG13. The copyright information inquiring includes the processings in steps SB4 to SB9 shown in FIG. 5. In the copyright information inquiring, however, the processings are executed in accordance with the “copyright inquiring flag” shown in FIG. 2B. In step SG5, the control section 57 substitutes 0 for a electronic message reception count value C4. In step SG6, the control section 57 increments the electronic message reception count value C4 by 1.

In step SG7, the control section 57 determines whether the copyright inquiring flag control electronic message A30 is a electronic message corresponding to a electronic message counter. When the determination result in step SG7 is “No”, the control section 57 generates a response electronic message (abnormal end) in step SG8.

However, when the determination result in step SG7 is “Yes”, the control section 57 determines in step SG9 whether the electronic message reception count value C4 is less than a preset threshold value T2 and in this case, sets the determination result to “Yes”. In step SG11, the control section 57 generates a response electronic message B30 (normal end). In step SG12, the control section 57 transmits the response electronic message B30 to the terminal unit 10.

Then, the response electronic message B30 is received by the control section 11 via the control section 57, communication control section 51, IC card reader/writer 40 and communication control section 12. Thereby, the control section 11 sets the determination result in step SF4 shown in FIG. 11 to “Yes”. In step SF5, the control section 11 determines whether the response electronic message B30 is a normal electronic message (the response electronic message B30 (normal end) generated in step SG11). When the determination result is “No”, the section 57 completes a series of processings.

In this case, when assuming the determination result in step SF5 as “Yes”, the control section 11 increments the electronic message reception count value C3 by 1 in step SF6. In step SF7, the control section 11 determines whether the electronic message reception count value C3 is less than the preset threshold value T2 and in this case, sets the determination result to “Yes” and repeats processings from the processing in step SF2 downward.

Then, when the determination result in step SG9 shown in FIG. 12 becomes “No”, the control section 57 sets the “copyright inquiring flag” shown in FIG. 2B in accordance with the copyright inquiring flag control electronic message A30 in step SG10. Moreover, when the determination result in step SF7 shown in FIG. 11 becomes “No”, the control section 11 executes copyright information inquiring in step SF8. The copyright information inquiring includes the processings in steps SA1 to SA5 shown in FIG. 4.

Moreover, according to the third embodiment, the copyright inquiring section 56 is started after it is confirmed that the communication between the terminal unit 10 and the IC card 50 is normally performed. Therefore, it is possible to avoid troubles including abnormal communication.

In the first embodiment, whether a copyright inquiry is present is controlled in accordance with the copyright inquiry information included in the request electronic message A10 (refer to FIG. 2A and FIG. 2B). However, it is also allowed to set the “copyright function flag” of the “first control information” or “second control information” shown in FIG. 2B in accordance with a request electronic message sent from the terminal unit 10 and execute copyright inquiring in accordance with the “copyright function flag”. Hereafter, the above case is described as fourth embodiment. The basic configuration of the fourth embodiment is the same as the configuration shown in FIG. 1.

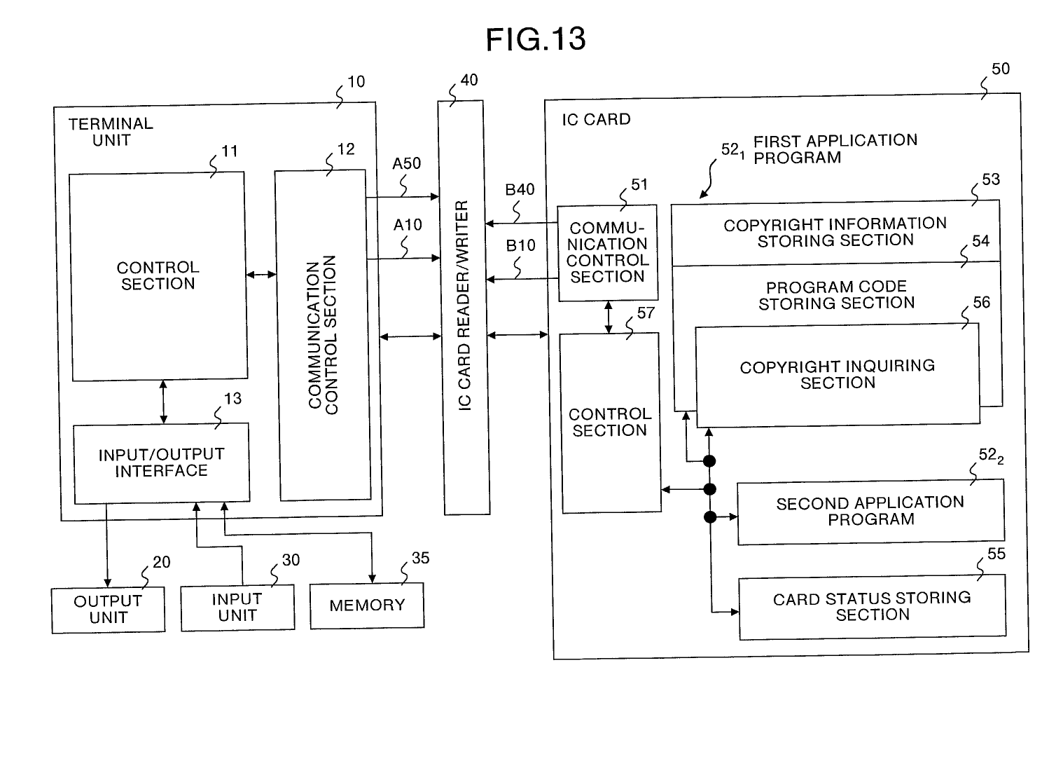

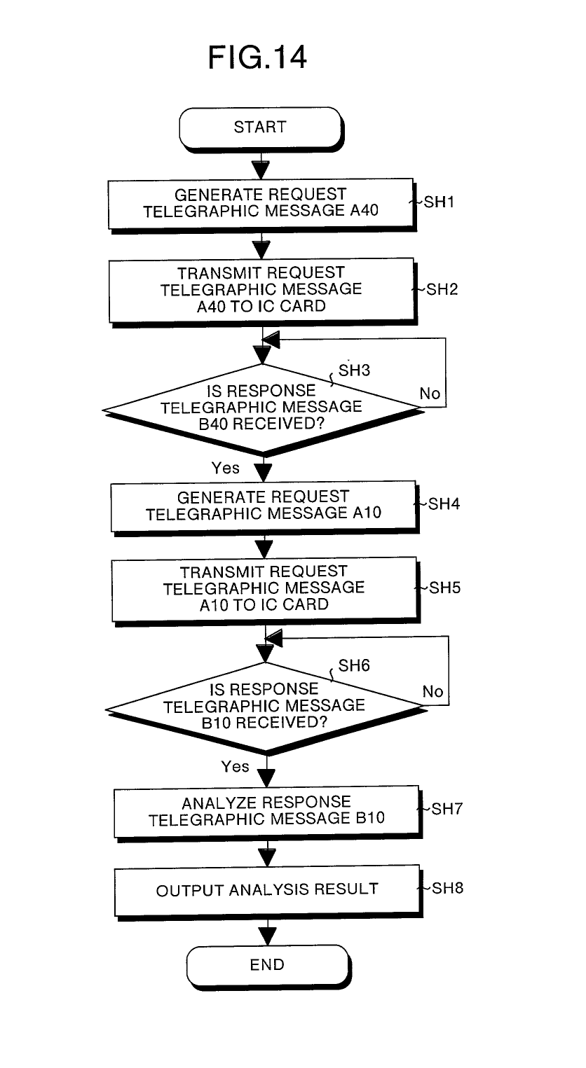

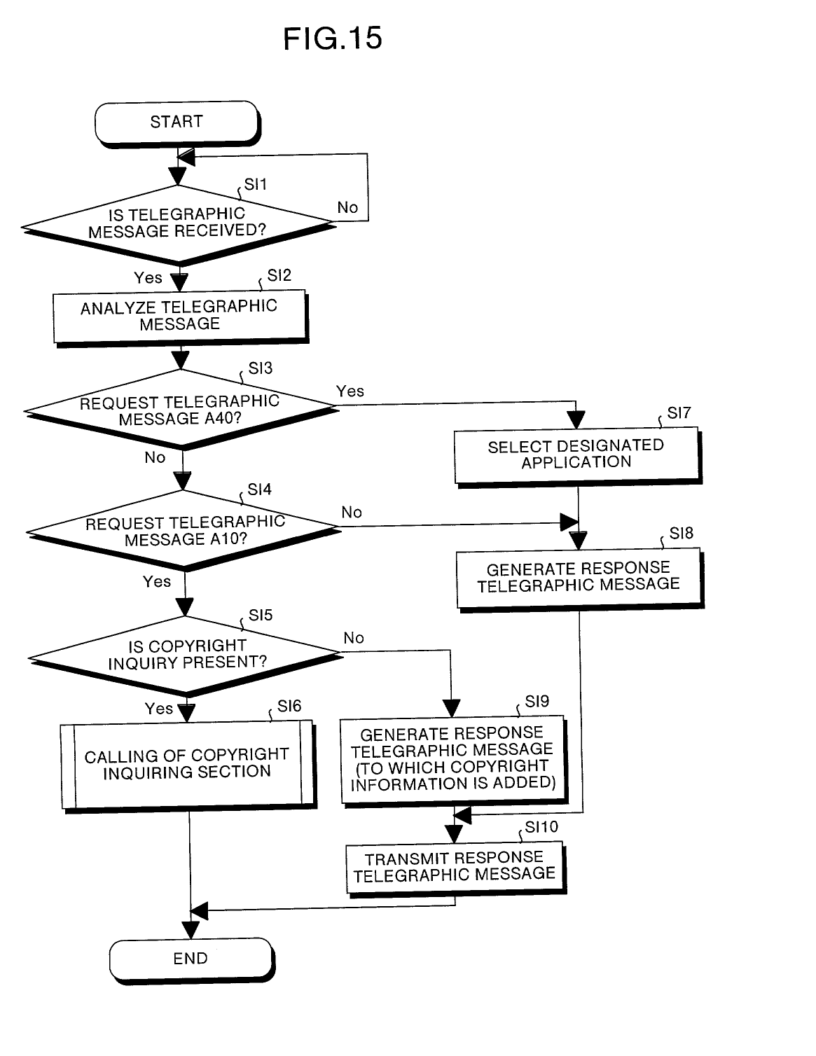

Then, operations of the fourth embodiment are described below by referring to FIG. 13 to FIG. 15. FIG. 13 is an illustration for explaining operations of the fourth embodiment. FIG. 14 is a flowchart for explaining operations of a control section 11 of the terminal unit 10 of the fourth embodiment. FIG. 15 is a flowchart for explaining operations of a control section 57 of an IC card 50 of the fourth embodiment.

First, in step S11 shown in FIG. 15, the control section 57 determines whether a electronic message is received. When the determination result is “No”, the section 57 repeats the above determination. In step SH1 shown in FIG. 14, however, the control section 11 generates a request electronic message A40. The request electronic message A40 is a electronic message for selecting an application program (in FIG. 13, first application program 52₁ or 52₂) stored in the IC card 50. Moreover, the request electronic message A40 includes the information for setting the “copyright inquiring function flag” of the “first control information” or “second control information” shown in FIG. 2B.

In step SH2, the control section 11 transmits the request electronic message A40 to the IC card 50. In step SH3, the control section 11 determines whether a response electronic message B40 is received from the IC card 50. When the determination result is “No”, the section 11 repeats the above determination.

Then, when the request electronic message A40 is received by the control section 57 via a communication control section 12, IC card reader/writer 40 and communication control section 51, the control section 57 sets the determination result in step SI1 shown in FIG. 15 to “Yes”. In step SI2, the control section 57 analyzes the received electronic message. In step SI3, the control section 57 determines whether the received electronic message is the request electronic message A40 in accordance with the analysis result in step SI2 and in this case, sets the determination result to “Yes”.

In step SI7, the control section 57 selects an application program (in this case, the first application program 52₁) designated in accordance with the request electronic message A40. Then, the control section 57 sets the “currently executed application program identifying information”, “currently executed application program status” and“copyright inquiring function flag” of the “first control information” (or second control information) shown in FIG. 2B.

In step SI8, the control section 57 generates a response electronic message B40. In step SI9, the control section 57 transmits the response electronic message B40 to the terminal unit 10. The response electronic message B40 is received by the control section 11 via the communication control section 51, IC card reader/writer 40 and communication control section 12. Thereby, the control section 11 sets the determination result in step SH3 to “Yes”.

In step SH4, the control section 11 generates a request electronic message A10. The request electronic message A10 is a electronic message for selecting an application program (in this case, first application program 52₁) stored in the IC card 50. In step SH5, the control section 11 transmit the request electronic message A10 to the IC card 50. In step SH6, the control section 11 determines whether a response electronic message B10 is received from the IC card 50. When the determination result is “No”, the section 11 repeats the above determination.

Then, when the request electronic message A10 is received by the control section 57 via the communication control section 12, the IC card reader/writer 40 and the communication control section 51, the control section 57 sets the determination result shown in FIG. 15 to “Yes”. In step SI2, the control section 57 analyzes the received electronic message. In step SI3, the control section 57 determines whether the received electronic message is the request electronic message A40 in accordance with the analysis result in step SI2 and in this case, sets the determination result to “No”.

In step SI4, the control section 57 determines whether the received electronic message is the request electronic message A10 and in this case, sets the determination result to “Yes”. In step SI5, the control section 57 recognizes a designated application program (in this case, first application program 52₁) in accordance with the request electronic message A10. Then, the control section 57 refers to the “copyright inquiring function flag” (in this case, it is assumed that the flag is present) of the “first control information” (or second control information) shown in FIG. 2B corresponding to a currently executed application program to determine whether there is a copyright inquiry.

In this case, the control section 57 sets the determination result in step SI5 to “Yes”. In step SI6, the control section 57 calls a copyright inquiring section 56. Thereby, in step SC1 shown in FIG. 6, the copyright inquiring section 56 reads the copyright information about the first application program 52₁ from a copyright information storing section 53. In step SC2, the copyright inquiring section 56 generates a response electronic message B10 to which the above copyright information is added. In step SC3, the copyright inquiring section 56 transmits the response electronic message B10 to the terminal unit 10.

Then, the response electronic message B10 is received by the control section 11 via the control section 57, communication control section 51, IC card reader/writer 40 and communication control section 12. Thereby, the control section 11 sets the determination result in step SH6 shown in FIG. 14 to “Yes”. In step SH7, the control section 11 analyzes the response electronic message B10. In step SH8, the control section 11 outputs the copyright information about the first application program 52₁ to an output unit 20 as an analysis result.

However, when the determination result in step SI4 shown in FIG. 15 is “No”, the control section 57 generates a response electronic message in step SI8. In step SI10, the control section 57 transmits the response electronic message to the terminal unit 10. Moreover, when the determination result in step SI5 is “No”, the control section 57 generates a response electronic message (to which copyright information is not added) in step SI9. In step SI10, the control section 57 transmits the above response electronic message to the terminal unit 10.

As described above, the fourth embodiment sets whether a copyright inquiry is set by the terminal unit 10 and starts the copyright inquiring section 56 only when the copyright inquiry is present. Therefore, it is possible to control inquiring about copyright information from an external unit.

In the first embodiment, whether a copyright inquiry is present is controlled in accordance with the copyright inquiry information included in the request electronic message A10 (refer to FIG. 2A and FIG. 2B). However, it is also allowed to discriminate an application program identifier included in a request electronic message sent from the terminal unit 10 and execute copyright inquiring about an application program corresponding to the application program identifier. Hereafter, this case is described as fifth embodiment. The basic configuration of the fifth embodiment is the same as the configuration shown in FIG. 1.

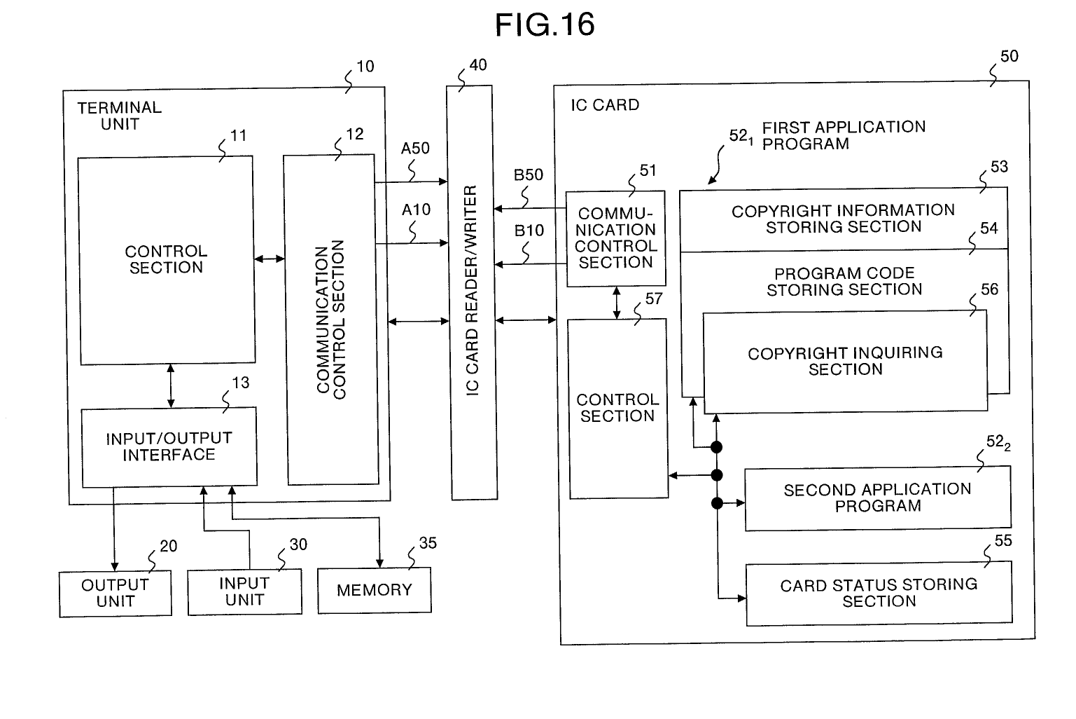

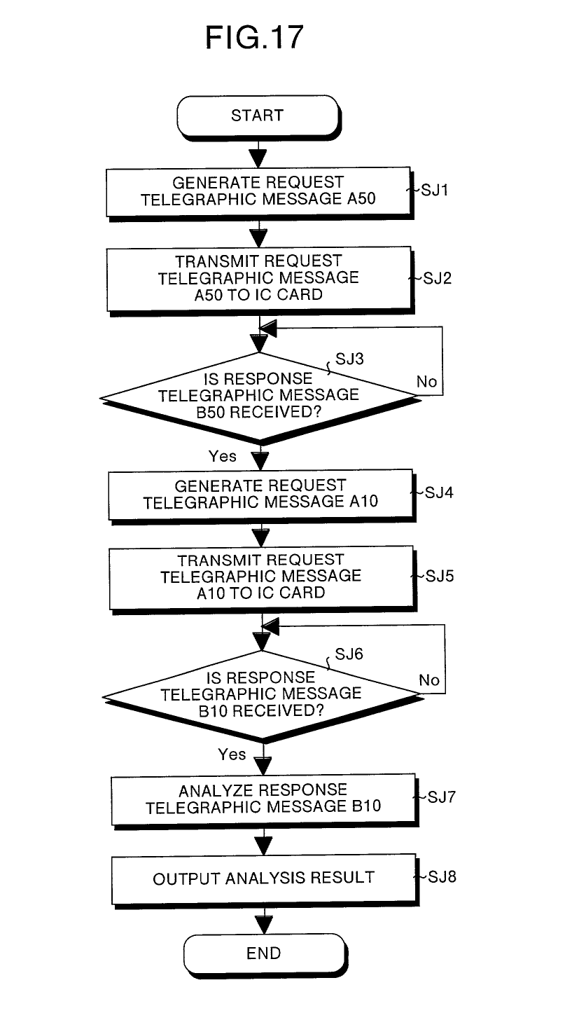

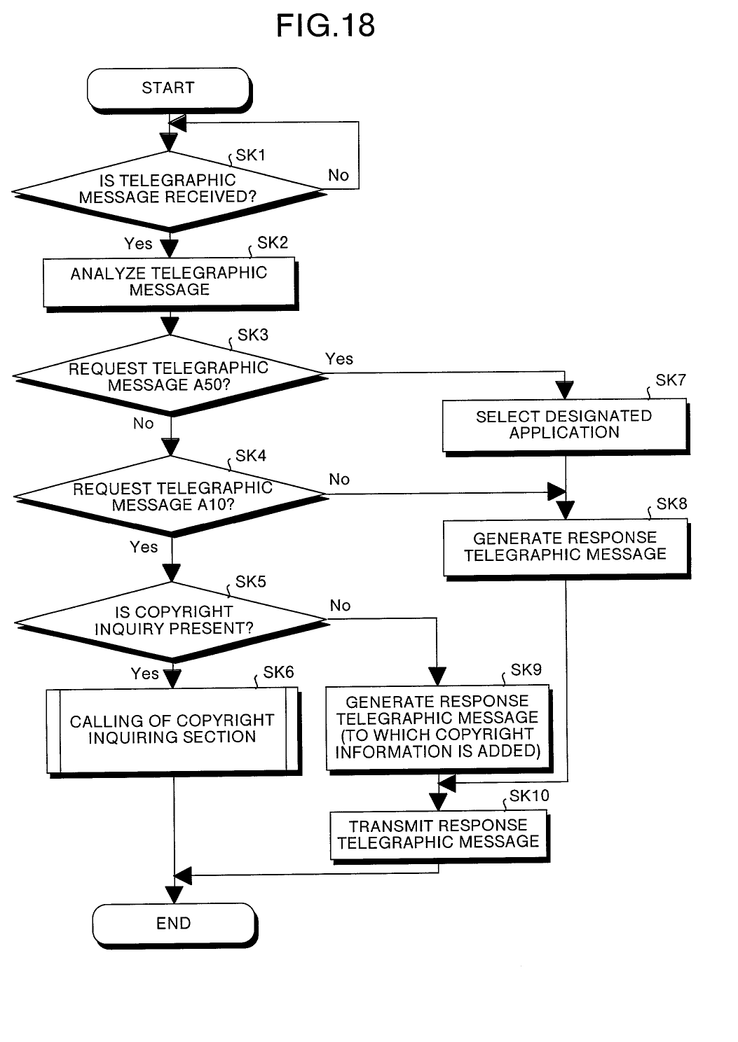

Then, operations of the fifth embodiment are described below by referring to FIG. 16 to FIG. 18. FIG. 16 is an illustration for explaining operations of the fifth embodiment. FIG. 17 is a flowchart for explaining operations of a control section 11 of the terminal unit 10 of the fifth embodiment. FIG. 18 is a flowchart for explaining operations of a control section 57 of an IC card of the fifth embodiment.

First, in step SK1 shown in FIG. 18, the control section 57 determines whether a electronic message is received. When the determination result is “No”, the section 57 repeats the above determination. In step SJ1 shown in FIG. 17, the control section 11 generates a request electronic message A50. The request electronic message A50 is a electronic message for selecting an application program (in FIG. 16, first application program 52₁ or 52₂) stored in the IC card 50.

In step SJ2, the control section 11 transmits the request electronic message A50 to the IC card 50. In step SJ3, the control section 11 determines whether a response electronic message B50 is received from the IC card 50. When the determination result is “No”, the section 11 repeats the above determination.

Then, when the request electronic message A50 is received by the control section 57 via a communication control section 12, IC card reader/writer 40 and communication control section 51, the control section 57 sets the determination result in step SK1 to “Yes”. In step SK2, the control section 57 analyzes the receiver electronic message.

In step SK3, the control section 57 determines whether the received electronic message is the request electronic message A50 in accordance with the analysis result in step SK2 and in this case, sets the determination result to “Yes”. In step SK7, the control section 57 selects an application program (in this case, first application program 52₁) designated by the request electronic message A50. Then, the control section 57 sets an identifier for calling the selected application program.

In step SK8, the control section 57 generates a response electronic message B50. In step SK9, the control section 57 transmits the response electronic message B50 to the terminal unit 10. The response electronic message B50 is received by the control section 11 via the communication control section 51, IC card reader/writer 40 and communication control section 12. Thereby, the control section 11 sets the determination result in step SJ3 shown in FIG. 17 to “Yes”.

In step SJ4, the control section 11 generates a request electronic message A10. The request electronic message A10 is a electronic message for selecting an application program (in this case, first application program 52₁) stored in the IC card 50. Moreover, the request electronic message A10 includes an application program identifier for identifying an application program (first application program 52₁ or second application program 52₂).

In step SJ5, the control section 11 transmits the request electronic message A10 to the IC card 50. In step SJ6, the control section 11 determines whether a response electronic message B10 is received from the IC card 50. When the determination result is “No”, the control section 11 repeats the above determination.

Then, when the request electronic message A10 is received by the control section 57 via the communication control section 12, the IC card reader/writer 40 and the communication control section 51, the control section 57 sets the determination result in step SK1 shown in FIG. 18 to “Yes”. In step SK2, the control section 57 analyzes the received electronic message. In step SK3, the control section 57 determines whether the received electronic message is the request electronic message A50 in accordance with the analysis result in step SK2 and in this case, sets the determination result to “No”.

In step SK4, the control section 57 determines whether the received electronic message is the request electronic message A10 and in this case, sets the determination result to “Yes”. In step SK5, the control section 57 determines whether an application program identifier about a designated application program according the request electronic message A10 (in this case, first application program 52₁) coincides with an identifier for calling an application program set in step SK7 and determines whether a copyright inquiry is present by referring to the “copyright inquiring function flag” (in this case, it is assumed that the flag is present) of the “first control information” (or second control information) shown in FIG. 2B only when the above both identifiers coincide with each other.

In this case, the control section 57 sets the determination result in step SK5 to “Yes”. In step SK6, the control section 57 calls a copyright inquiring section 56. Thereby, in step SC1 shown in FIG. 6, the copyright inquiring section 56 reads the copyright information about the first application program 52, from the copyright information storing section 53. In step SC2, the copyright inquiring section 56 generates a response electronic message B10 to which the above copyright information is added. In step SC3, the copyright inquiring section 56 transmits the response electronic message B10 to the terminal unit 10.

Then, the response electronic message B10 is received by the control section 11 via the control section 57, communication control section 51, IC card reader/writer 40 and communication control section 12. Thereby, the control section 11 sets the determination result in step SJ6 shown in FIG. 17 to “Yes”. In step SJ7, the control section 11 analyzes the response electronic message B10. In step SJ8, the control section 11 outputs the copyright information about the first application program 52₁ to the output unit 20 as an analysis result.

However, when the determination result in step SK4 shown in FIG. 18 is “No”, the control section 57 generates a response electronic message in step SK8. In step SK10, the control section 57 transmits the response electronic message to the terminal unit 10. Moreover, when the determination result in step SK5 is “No”, the control section 57 generates a response electronic message (to which copyright information is not added) in step SK9. In step SK10, the control section 57 transmits the above response electronic message to the terminal unit 10.

As described above, according to the fifth embodiment, whether a copyright inquiry is present is set by the terminal unit 10 and the copyright inquiring section 56 is started only when the copyright inquiry is present. Therefore, it is possible to control inquiring about copyright information from an external unit.

As the first embodiment, a case is described in which a copyright information storing section and a copyright inquiring section are included in application programs 52₁ and 52₂ respectively as shown in FIG. 1. However, it is also allowed to make a copyright information storing section independent of an application program and form a copyright inquiring section shared by a plurality of application programs. Hereafter, the above case is described as sixth embodiment.

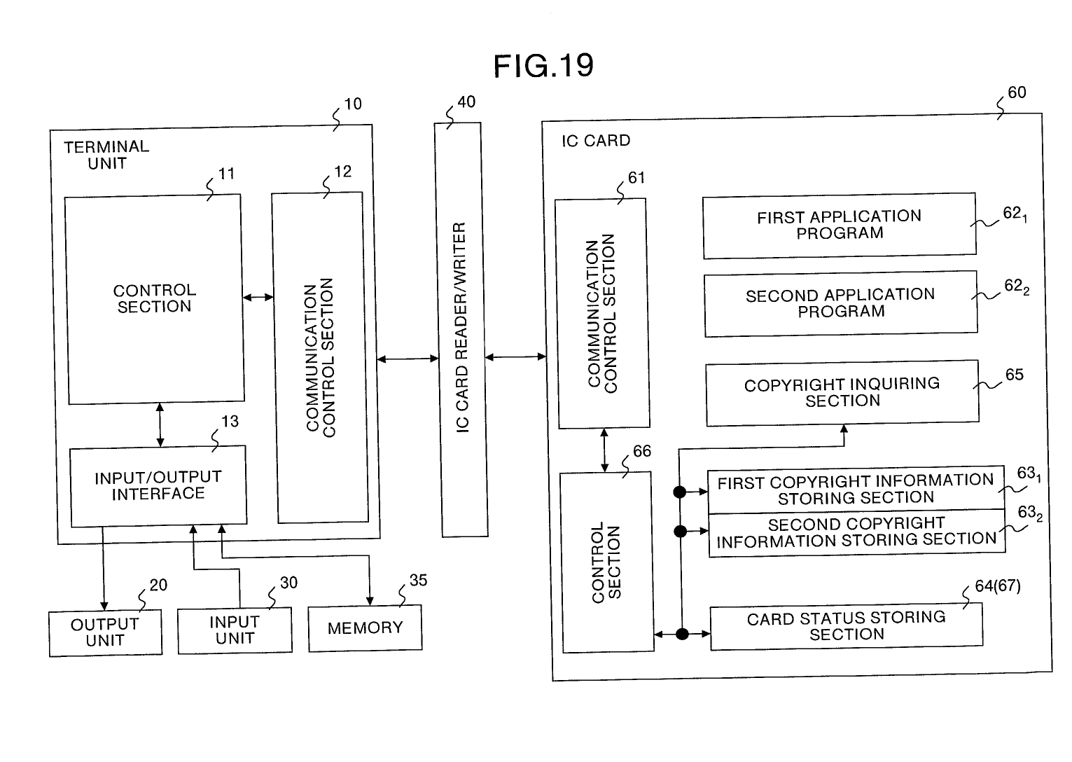

FIG. 19 is a block diagram showing a configuration of sixth embodiment of the present invention. In FIG. 19, a portion corresponding to a portion in FIG. 1 is provided with the same symbol. In FIG. 19, an IC card 60 is provided instead of the IC card 50 shown in FIG. 1. The IC card 60 stores a first application program 62₁ and a second application program 622 to be executed by an IC.

Only a program code storing section is provided for the first application program 62₁ and second application program 62₂ respectively. A first copyright information storing section 63₁ stores the copyright information about the first application program 62₁ and is provided independently of the first application program 62₁.

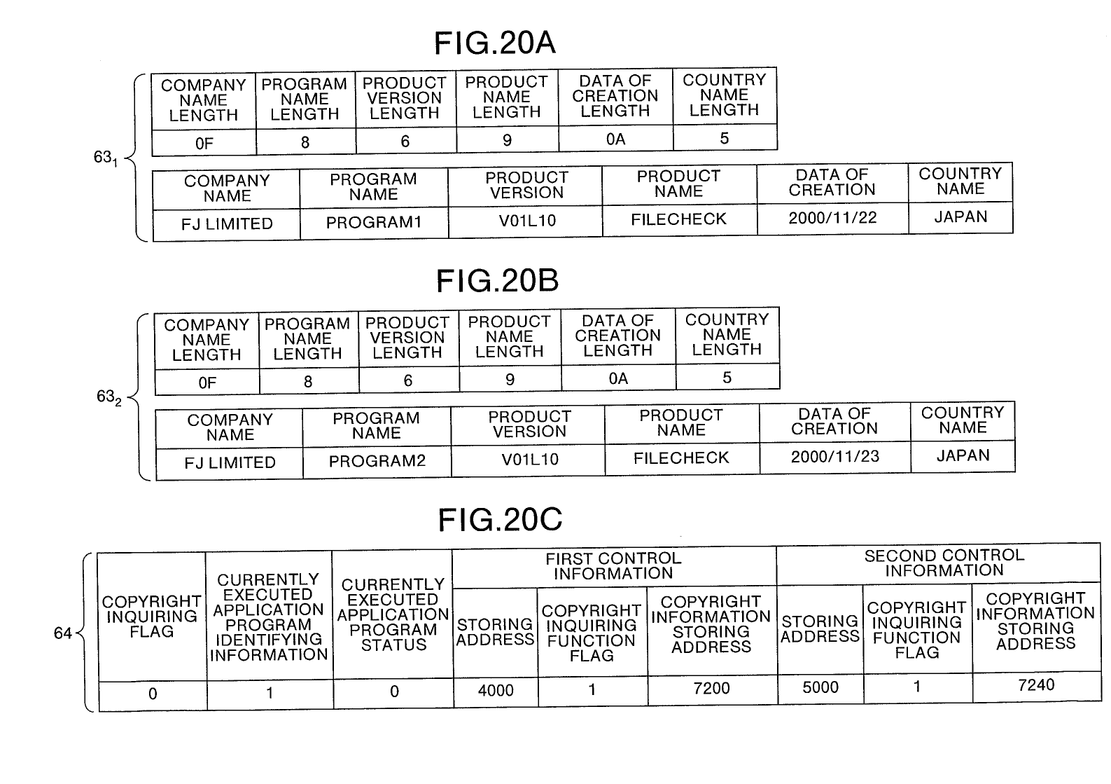

Specifically, the copyright information storing section 63₁ stores the copyright information about the first application program 62₁ as shown in FIG. 20A. The copyright information includes “company name”, “program name”, “product version”, “product name”, “date of creation” and “country name”.

A second copyright information storing section 63₂ stores the copyright information about the second application program 62₂ and is provided independently of the first application program 62₂. Specifically, the second copyright information storing section 63₂ stores the copyright information about the second application program 62₂ as shown in FIG. 20B. The copyright information includes “company name”, “program name”, “product version”, “product name”, “date of creation” and “country name”. Data structures of the first copyright information storing section 63₁ and second copyright information storing section 63₂ are the same as the data structure of the control section 52 shown in FIG. 2A.

In FIG. 19, a card status storing section 64 stores a card status. Specifically, as shown in FIG. 20C, the section 64 has fields of “copyright inquiring flag”, “currently executed application program identifying information”, “currently executed application program status”, “first control information” and “second control information”.

The “copyright inquiring flag” is a flag for controlling whether to perform inquiring of copyright information (hereafter referred to as copyright inquiring) in the IC card 60. To perform the copyright inquiring, 0 is set to the “copyright inquiring flag”. However, when the copyright inquiring is not performed, 1 is set to the “copyright inquiring flag”.

The “currently executed application program identifying information” is the information for identifying an application program currently executed in the IC card 60. When the first application program 62₁ is executed, 1 is set to the “currently executed application program identifying information”.

However, when the second application program 62₂ is executed, 2 is set to the “currently executed application program identifying information”. When neither application program is executed, 0 is set to the “currently executed application program identifying information” but the copyright inquiring is not performed.

A copyright processing status (0: copyright inquiring is not started) of an application program executed in the IC card 60 is set to the “currently executed application program status”. The “first control information” is constituted of “storing address”, “copyright inquiring flag” and “copyright information storing flag” corresponding to the first application program 62₁. The “storing address” is the information showing an address in which the first application program 62₁ is stored.

The “copyright inquiring function flag” is a flag for turning on/off a copyright inquiring function about the first application program 62₁. When the copyright inquiring function about the first application program 62₁ is turned off, 0 is set to the “copyright inquiring function flag”. However, when the copyright inquiring function about the first application program 62₁ is turned on, 1 is set to the “copyright inquiring function flag”. The “copyright information storing address” is the information showing the storing address of the first copyright information storing section 63₁.

The “second control information” is constituted of a “storing address”, “copyright inquiring function flag” and “copyright information storing address” corresponding to the second application program 62₂. The “storing address” is the information showing the address in which the second application program 62₂ is stored.

The “copyright inquiring function flag” is a flag for turning on/off the copyright inquiring function about the second application program 62₂. When the copyright inquiring function about the second application program 62₂ is turned off, 0 is set to the “copyright inquiring function flag”. When the copyright inquiring function about the second application program 62₂ is turned on, 1 is set to the “copyright inquiring function flag”. The “copyright information storing address” is the information showing the storing address of the second copyright information storing section 63₂.

A copyright inquiring section 65 executes inquiring of the copyright information about the first application program 62₁. A copyright inquiring section (not illustrated) having the same function as the copyright inquiring section 65 is also provided for the second application program 62₂. A control section 66 controls various sections and details of operations of the control section 66 will be described later.

Operations of the above sixth embodiment are the same as those of the first embodiment (refer to FIG. 3) In the case of the sixth embodiment, however, the control section 66 and copyright inquiring section 65 execute processings instead of the control section 57 and copyright inquiring section 56 shown in FIG. 3. Therefore, in the sixth embodiment, processings are executed in accordance with flowcharts shown in FIG. 4 to FIG. 6.

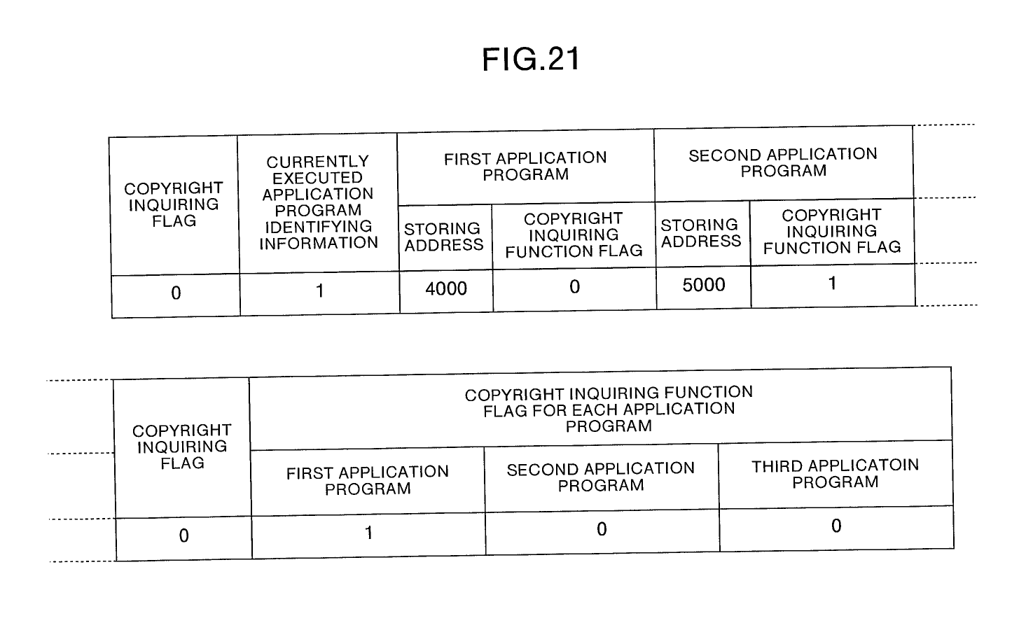

Moreover, in case of the sixth embodiment, it is also allowed to form the card status storing section 67 shown in FIG. 21 instead of the card status storing section 64 shown in FIG. 20C. The card status storing section 67 has fields of a “copyright inquiring flag”, “currently executed application program identifying information”, “currently executed application program status”, “first application program”, “second application program”, “copyright inquiring flag” and “copyright inquiring function flag for each application program”.

The “copyright inquiring flag” is a flag for controlling whether to perform inquiring of copyright information (hereafter referred to as copyright inquiring) in the IC card 60. When performing copyright inquiring, 0 is set to the “copyright inquiring flag”. When not performing copyright inquiring, 1 is set to the “copyright inquiring flag”.

The “currently executed application program identifying information” is the information for identifying an application program currently executed in the IC card 60. When the first application program 62₁ is executed, 1 is set to the “currently executed application program identifying information”.

However, when the second application program 62₂ is executed, 2 is set to the “currently executed application program identifying information”. However, when neither application program is executed, 0 is set to the “currently executed application program identifying information” but copyright inquiring is not performed.

A copyright processing status of an application program currently executed in the IC card 60 (0: copyright inquiring is not started) is set to the “currently executed application program status”. The “first control information” is constituted of “storing address”, “copyright inquiring function flag” and “copyright information storing address” corresponding to the first application program 62₁. The “storing address” is the information showing the address in which the first application program 62₁ is stored.

The “copyright inquiring function flag” is a flag for turning on/off the copyright inquiring function about the first application program 62₁. When the copyright inquiring function about the first application program 62₁ is turned off, 0 is set to the “copyright inquiring function flag”. When the copyright inquiring function about the first application program 62₁ is turned on, 1 is set to the “copyright inquiring function flag”. The “copyright information storing address” is the information showing the storing address of the first copyright information storing section 63₁.

The “second control information” is constituted of a “storing address”, “copyright inquiring function flag” and “copyright information storing address” corresponding to the second application program 62₂. The “storing address” is the information showing the address in which the second application program 62₂ is stored.

The “copyright inquiring function flag” is a flag for turning on/off the copyright inquiring function about the second application program 62₂. When the copyright inquiring function about the second application program 62₂ is turned off, 0 is set to the “copyright inquiring function flag”. However, when the copyright inquiring function about the second application program 62₂ is turned on, 1 is set to the “copyright inquiring function flag”. The “copyright information storing address” is the information showing the storing address of the second copyright information storing section 63₂. According to the sixth embodiment, the same advantages as the first embodiment are obtained.

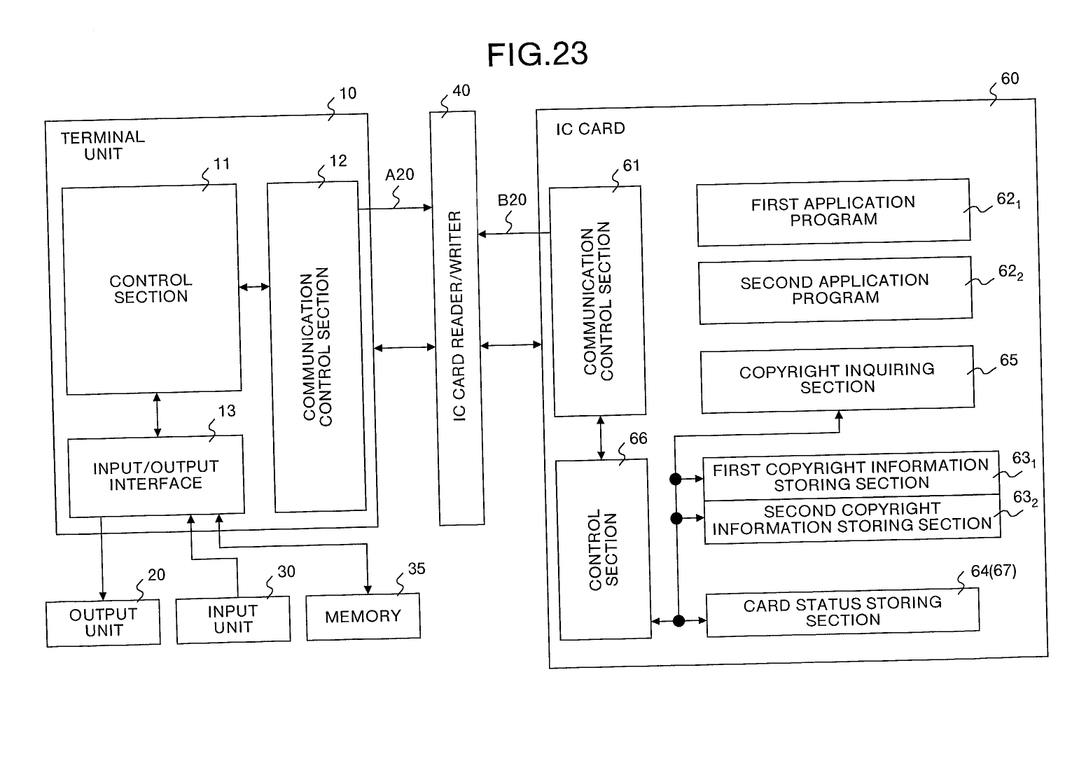

FIG. 23 is an illustration for explaining operations according to the seventh embodiment. The configuration of the seventh embodiment is the same as the configuration shown in FIG. 19. Operations of the seventh embodiment are the same as those of the second embodiment (refer to FIG. 7) as shown in FIG. 23. In the case of the seventh embodiment, however, a control section 66 and a copyright inquiring section 65 execute processings instead of the control section 57 and copyright inquiring section 56 shown in FIG. 7. Therefore, in case of the seventh embodiment, various processings are executed in accordance with flowcharts shown in FIG. 6, FIG. 8 and FIG. 9. According to the seventh embodiment, advantages same as those of the second embodiment are obtained.

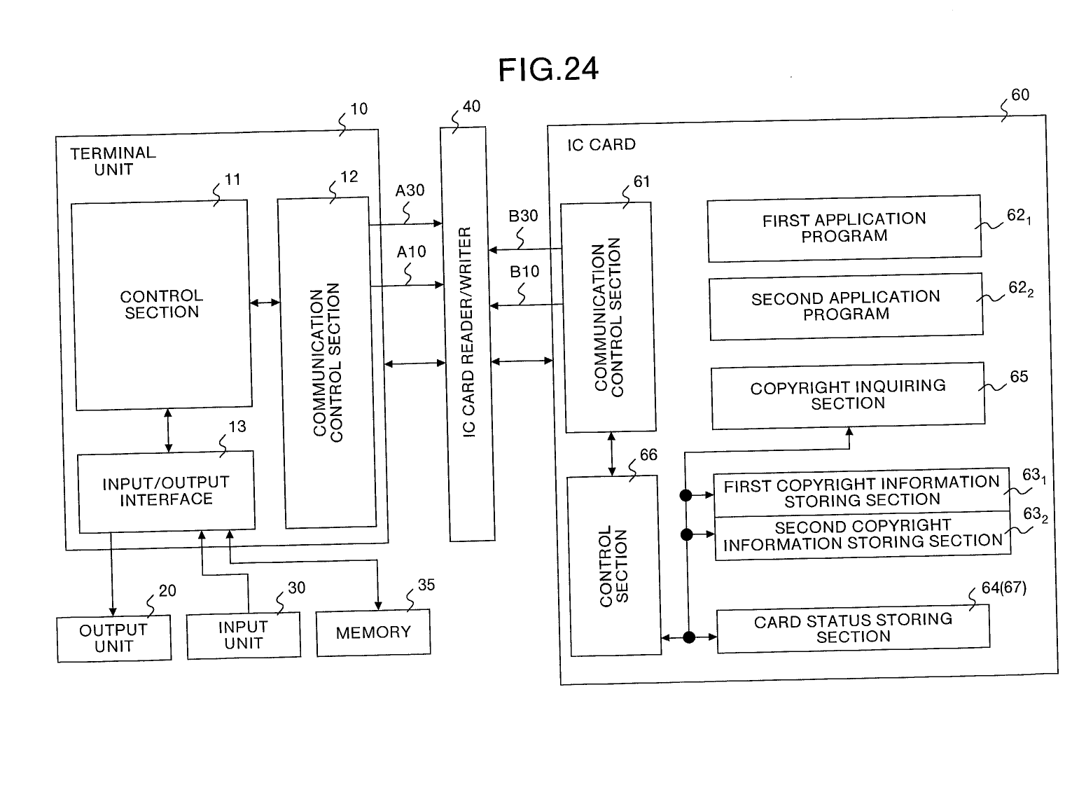

FIG. 24 is an illustration for explaining operations according to the eighth embodiment. The configuration of the eighth embodiment is the same as the configuration shown in FIG. 19. Operations of the eighth embodiment are the same as those of the third embodiment (refer to FIG. 10) as shown in FIG. 24. In the case of the eighth embodiment, however, a control section 66 and a copyright inquiring section 65 execute processings instead of the control section 57 and copyright inquiring section 56 shown in FIG. 10. Therefore, in case of the eighth embodiment, various processings are executed in accordance with flowcharts shown in FIG. 6, FIG. 11 and FIG. 12. According to the eighth embodiment, the same advantages as the third embodiment are obtained.

First to eighth embodiments are described above by referring to the accompanying drawings. However, specific configurations are not restricted to these embodiments. Design modifications not deviated from the gist of the present invention are included in the present invention. For example, it is allowed to combine two or more embodiments.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

As described above, according to the present invention, a program stored in the IC card is designated by the program designating unit to boot the copyright information inquiring unit. Therefore, an advantage is obtained that it is possible to inquire the copyright information about the program concerned from an external unit.

Moreover, it is confirmed that communication is normally performed between the IC card side transceiving unit and the transceiving unit and thereafter, copyright information inquiring unit is started. Therefore, an advantage is obtained that it is possible to avoid a trouble such as abnormal communication.

Furthermore, whether a copyright information inquiry is set so as to boot the copyright information inquiring unit only when the copyright information inquiry is present. Therefore, an advantage is obtained that it is possible to control inquiring of copyright information from an external unit.

Furthermore, the copyright information inquiring unit is repeatedly boot for a predetermined number of times. Therefore, an advantage is obtained that it is possible to inquire copyright information even if a slight communication trouble occurs.

Furthermore, the copyright information is enciphered and decoded by the decoding unit. Therefore, an advantage is obtained that it is possible to improve the security.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A copyright information inquiring apparatus comprising:
a program designating unit which designates a program stored in an IC card through communication unit;
a booting unit which boots a copyright information inquiring unit which inquires the copyright information about a program designated by said program designating unit provided in said IC card; and
a receiving unit which receives the copyright information inquired by said copyright information inquiring unit.

2. The copyright information inquiring apparatus according to claim 1 further comprises a transceiving unit which transceives data to and from said IC card side transceiving unit provided in said IC card,
wherein said booting unit confirms that communication between said IC card side transceiving unit and said transceiving unit is normally performed and then, boots said copyright information inquiring unit.

3. The copyright information inquiring apparatus according to claim 1 further comprises a setting unit which sets whether a copyright information inquiry is to be performed or not through said communication unit,
wherein said booting unit boots said copyright information inquiring unit only when said setting unit has set that the copyright information inquiry is to be performed.

4. The copyright information inquiring apparatus according to claim 1,
wherein said starting unit repeatedly boots said copyright information inquiring unit for predetermined number of times.

5. The copyright information inquiring apparatus according to claim 1 further comprising a decoding unit which decodes the copyright information enciphered by an enciphering unit provided in said IC card.

6. A copyright information inquiring system comprising an IC card and an information inquiring apparatus,
said IC card having,
a memory which stores a plurality of application programs; and
an IC card side communication unit for transreceiving data to and from said information inquiring apparatus,
said information inquiring apparatus having,
an apparatus side communication unit for transreceiving data to and from said IC card;
a program designating unit which designates one application program out of the plurality of application programs stored in said IC card;
a copyright information inquiring unit which inquires the copyright information about the application program designated by said program designating unit; and
a booting unit which boots said copyright information inquiring unit; and
a receiving unit which receives the copyright information inquired by said copyright information inquiring unit.
